(19) United States
(12) Patent Application Publication
(10) Pub. No.: US 2024/0137332 A1
(43) Pub. Date: Apr. 25, 2024

(54) TRANSMISSION OF A SIGNAL FROM A FIRST ELECTRONIC COMPONENT OF A VEHICLE TO AT LEAST ONE SECOND ELECTRONIC COMPONENT OF THE VEHICLE

(71) Applicant: PSA AUTOMOBILES SA, Poissy (FR)

(72) Inventors: Antony BOISSERIE, Wissous (FR); Jean Marc ROMAIN, Pontault Combault (FR)

(21) Appl. No.: 18/546,669

(22) PCT Filed: Feb. 14, 2022
(86) PCT No.: PCT/FR2022/050261

§ 371 Date: Aug. 16, 2023

(30) Foreign Application Priority Data
Mar. 23, 2021 (FR) FR2102855

(51) Int. Cl. H04L 49/118; H04L 49/15

(52) U.S. Cl. CPC H04L 49/118; H04L 49/15

(57) ABSTRACT

Method and device for transmitting a signal from a first electronic component of a vehicle to at least one second electronic component of the vehicle.

The invention relates to a method for transmitting a signal from a first electronic component of a vehicle to at least one second electronic component of the vehicle, said signal being formed from a frame of a low-level network protocol and being transmitted via transceivers of a packet-switching protocol, said method comprising the following steps:
receiving (41) the signal on a physical input port of a network switch;
redirecting (42) a frame extracted from the received signal to an output port of the network switch on the basis of a destination address extracted from said frame;
transmitting (43) a signal, generated from the frame, to the electronic component identified by the extracted destination address via said output port of the network switch to which said electronic component is connected.

The invention also relates to a network switch and a vehicle carrying this network switch.

### CROSS-REFERENCE TO RELATED APPLICATIONS

This application is the US National Stage under 35 USC § 371 of International Application No. PCT/FR2022/050261, filed Feb. 14, 2022, which claims the priority of French application 2102855 filed on Mar. 23, 2021, the content (text, drawings and claims) of both said applications being incorporated by reference herein.

### BACKGROUND

The methods and devices described herein relate to methods and devices for transmitting a signal from a first electronic component of a vehicle to at least one second electronic component of the vehicle. In particular, switching between a low-level protocol and a packet-switching protocol is described.

Many applications, in particular in the automotive field, increasingly need bandwidth in the communication networks to transmit, for example, images, audio streams or video streams.

In the automotive field, electronic components onboard vehicles, such as, for example, ECUs (Electronic Control Units), or on an onboard computer, communicate with one another by frames of low-level network protocols such as the Controller Area Network (CAN). This protocol made it possible to reduce the number of wires used for the transmissions within the vehicle by multiplexing the data. There are different versions of the protocol, aimed at increasing its bandwidth. However, the various evolutions of the CAN protocol do not lead to sufficient bandwidths. Furthermore, the protocol steps for transmission/reception of CAN protocol frames in particular involve error detection and error signaling mechanisms which consume computing resources, in particular for the components in charge of low layers.

Also, other protocols such as in particular a packet-switching protocol like Ethernet have been used in vehicles. However, these packet-switching protocols and more particularly the Ethernet protocol, having been designed for exchanges between computers, involve high-level processing (application layers) that is difficult to implement on all the low-level computers of a vehicle.

There is therefore a need for a protocol capable of managing large bandwidths while being compatible with a wide variety of electronic components of the vehicle.

### SUMMARY

One object is to transmit a frame of a low-level network between several electronic components of a vehicle via transceivers of a packet-switching protocol.

According to a first aspect, a method for transmitting a signal from a first electronic component of a vehicle to at least one second electronic component of the vehicle, said signal being formed from a frame of a low-level network protocol and being transmitted via transceivers of a packet-switching protocol, comprises the following steps:
receiving the signal on a physical input port of a network switch;
redirecting a frame extracted from the received signal to an output port of the network switch on the basis of a destination address extracted from said frame;
transmitting a signal, generated from the frame, to the electronic component identified by the extracted destination address via said output port of the network switch to which said electronic component is connected.

According to one embodiment, the frame is redirected to an output port whose number is stored in an addressing table in association with a destination address identical to the destination address extracted from the frame.

According to one variant, the destination address extracted from the frame is stored in the addressing table in association with the number of the input port if this association is not already stored in the addressing table.

According to one embodiment, the frame is redirected to an output port whose number is stored in the addressing table in association with a destination address of the packet-switching protocol obtained from a destination address identical to a destination address extracted from the frame.

According to one variant, the destination address of the packet-switching protocol is stored in the addressing table in association with the number of the input port if this association is not already stored in the addressing table.

According to one embodiment, the method further comprises a step of extracting a source address of the frame and storing said source address in an addressing table in association with the number of the input port of the network switch on which the frame is received.

According to one embodiment, the method further comprises a step of extracting a source address of the frame and storing a source address of the packet-switching protocol obtained from said extracted source address, in an addressing table in association with the number of the input port of the network switch on which the frame is received.

According to one embodiment, the frame being a frame of the low-level protocol or a frame of the packet-switching protocol, information is stored to identify whether an input port of the network switch accepts frames of low-level protocol or frames of the packet-switching protocol.

A second aspect relates to a network switch comprising a memory unit associated with at least one processor configured to implement the steps of the method according to the first aspect.

A third aspect relates to a vehicle, for example a motor vehicle, comprising a device as described above according to the second aspect.

A fourth aspect also relates to a computer program that comprises instructions suitable for executing the steps of the method, according to the first aspect, particularly when said computer program is executed by at least one processor.

Such a computer program can use any programming language, and be in the form of a source code, an object code, or an intermediate code between a source code and an object code, such as in a partially compiled form, or in any other desirable form.

A fifth aspect relates to a computer-readable recording medium on which is recorded a computer program comprising instructions for the execution of the steps of the method according to the first aspect.

On the one hand, the recording medium can be any entity or device capable of storing the program. For example, the medium may comprise a storage means, such as a ROM memory, a CD-ROM or a ROM memory of the microelectronic circuit type, or a magnetic recording means or a hard drive.

On the other hand, this recording medium can also be a transmissible medium such as an electrical or optical signal, such a signal able to be conveyed via an electrical or optical cable, by conventional or microwave radio, or by self-directional laser beam or by other means. The computer program can in particular be downloaded over a network of the Internet type.

Alternatively, the recording medium can be an integrated circuit wherein the computer program is incorporated, the integrated circuit being adapted to execute or to be used in the execution of the method in question.

### BRIEF DESCRIPTION OF THE FIGURES

Other features and advantages will become apparent from the description of the non-limiting embodiments below, with reference to the appended FIGS. 1 to 4, in which:

FIG. 1 schematically shows a system for transmitting a signal from a first electronic component of a vehicle to at least one second electronic component of the vehicle according to one non-limiting embodiment.

FIG. 2 schematically shows a frame of a low-level network protocol of the CAN XL type.

FIG. 3 schematically shows a frame of a network protocol of the Ethernet type.

FIG. 4 shows a flowchart of the various steps of a method for transmitting a signal from a first electronic component of a vehicle to at least one second electronic component of the vehicle according to a particular exemplary embodiment.

### DETAILED DESCRIPTION

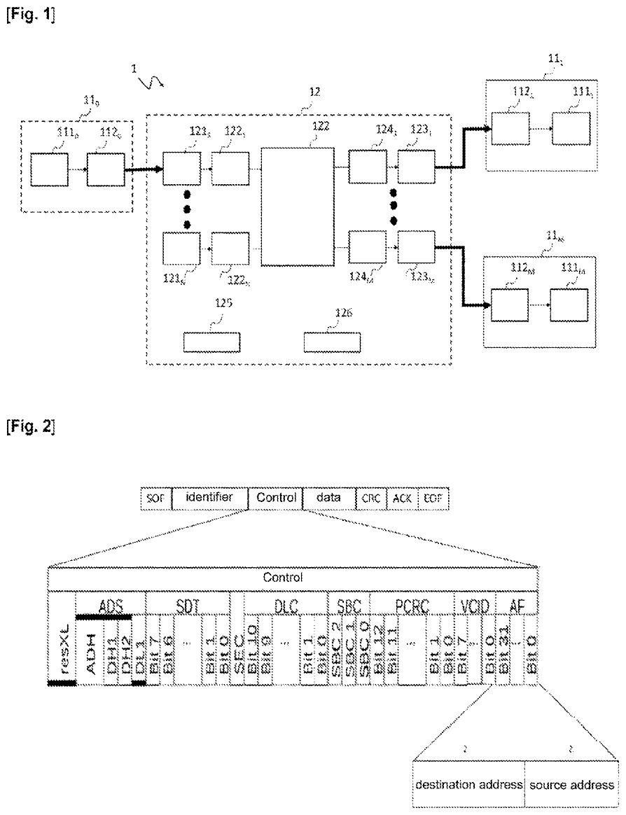

A method and a device for transmitting a signal by a first electronic component of a vehicle intended for at least one second electronic component of the vehicle will now be described in reference to FIGS. 1 to 4. The same elements are identified with the same reference signs throughout the following description.

The transmission, by an electronic component of a vehicle, of a frame T of a low-level network intended for several other electronic components of this vehicle configured to exchange signals through the transceivers according to a packet-switching protocol, uses a network switch supporting the routing of frames between input ports and output ports of that switch on the basis of an addressing table.

FIG. 1 schematically shows a system for transmitting a signal from a first electronic component of a vehicle to at least one second electronic component of the vehicle according to one non-limiting embodiment.

The system 1 comprises a first electronic component 11₀, at least one second electronic component 11₁ to 11_{M} and a network switch 12.

The network switch 12 comprises input ports 121₁ to 121_{N}, output ports 123₁ to 123_{M}, an addressing table 122, low-level protocol frame controllers 122₁ to 122_{N} and 124₁ to 124_{N}, one (or several) processors or microprocessors 125 and a memory 126.

The input ports 121₁ to 121_{N} and output ports 123₁ to 123_{M} of the network switch 12 are associated with transceivers (not shown) of a packet-switching protocol to be able to receive/transmit signals compliant with the physical layer of this packet-switching protocol. In addition, each input port 121₁ to 121_{N} is associated with a controller 122₁ to 122_{N} and each output port 123₁ to 123_{M} is associated with a controller 124₁ to 124_{M} which generates a signal from a frame of a low-level protocol so that this frame can be sent via the transceiver of one of the output ports 123₁ to 123_{M}.

Each electronic component 11ₘ (m=1 to M) comprises a port 112ₘ associated with a transceiver (not shown) of the packet-switching protocol, and a controller 111ₘ of the low-level protocol frame. Each electronic component 11ₘ (m=1 to M) is connected to an output port 123₁ to 123_{M} of the network switch 12.

Controllers 111ₘ (m=1 to M) are provided to retrieve frames T from signals received via the transceivers of ports 112ₘ (m=1 to M).

The electronic component 11₀ comprises a port 112₀ and a controller 111₀ provided to generate a signal from a frame T of the low-level protocol so that this frame T can be sent via the transceiver of the port 112₀.

A frame routing mechanism is implemented by the processor 125, the memory 126 and the addressing table 122. This mechanism is similar to that implemented by packet-switching protocol network switches.

In this type of packet-switching network switch, this mechanism uses an addressing table that stores source addresses of the packet-switching protocol, conventionally called the MAC source address, and destination addresses of the packet-switching protocol, conventionally called MAC destination addresses, associated with input and output port numbers of the network switch. Thus, following the receipt of a frame of the packet-switching protocol on an input port, a MAC destination address is extracted from the header of the received frame. This MAC destination address is compared to a MAC destination address of the addressing table that can then associate this MAC destination address with one or more of the output ports. The received frame is then redirected to this or these output port(s). If no MAC destination address is extracted from the header of the received frame then the received frame is redirected to all of the output ports. If the extracted MAC destination address is not stored in the addressing table, then it is stored in the addressing table in association with the number of the output port on which a recipient electronic component identified by this MAC destination address is connected. A MAC source address is also extracted from the header of the received frame and stored in the addressing table in association with the number of the input port on which the frame was received (if this MAC source address associated with this input port is not already stored in the addressing table). Thus, the addressing table can store a MAC source address of an electronic component transmitting a frame of the packet-switching protocol and connected to an input port, and a MAC destination address of an electronic component receiving a frame of the packet-switching protocol and connected to an output port, so that the frame received by the network switch is redirected to the destination electronic component.

However, the low-level protocol frame T is not a frame of a packet-switching protocol and the operation of the network switch must be adapted so that the low-level protocol frames T are redirected to output ports of that network switch.

In a first operation, a signal is generated from a low-level protocol frame T by the controller 111₀ of the electronic component 110. The signal is then sent via the transceiver of the port 112₀ and received via the transceiver of an input port, for example the port 121₁ of the network switch 12.

In a second operation, the frame T is then retrieved from the signal received by the controller 122₁ and this frame T is redirected to at least one controller 124ₘ and an associated output port 123ₘ on the basis of at least one destination address extracted from this frame T.

In a third operation, a signal is generated from the frame T by the controller 124ₘ associated with the output port 123ₘ. The signal is then sent to the recipient electronic component identified by the destination address extracted via the output port of the network switch 12 to which this electronic component is connected, and received on an input port, for example the port 112₁ of the recipient electronic component, in this case the electronic component 111 via the transceivers associated with those ports.

According to one embodiment of this first operation, the frame is redirected to an output port whose number is stored in the addressing table 122 in association with a destination address identical to the destination address extracted from the frame T.

According to one variant, the destination address extracted from the frame T is stored in the addressing table 122 in association with the number of the input port if this association is not already stored in the addressing table 122.

According to this embodiment, the addressing table stores addresses of the low-level protocol thus making it possible to implement the frame routing mechanism on the basis of the address of the low-level protocol.

According to one embodiment of this first operation, the frame T is redirected to an output port whose number is stored in the addressing table 122 in association with a MAC destination address of the packet-switching protocol obtained from a destination address identical to the destination address extracted from the frame T.

According to one variant, the MAC destination address is stored in the addressing table 12 in association with the number of the input port if this association is not already stored in the addressing table 122.

According to this embodiment, the addressing table stores addresses of the packet-switching protocol thus making it possible to implement the frame routing mechanism on the basis of the address of the packet-switching protocol.

In a fourth operation (optional), a source address of the low-level protocol is extracted from the frame T.

According to one variant, the extracted source address is stored in the addressing table 122 in association with the number of the input port if this association is not already stored in the addressing table 122.

According to one variant, a MAC source address is obtained from this extracted source address.

According to one variant, the MAC source address is stored in the addressing table 122 in association with the number of the input port if this association is not already stored in the addressing table 122.

Thus, the addressing table 122 can associate a source and/or destination address of either the low-level protocol or the packet-switching protocol with each of the input and output ports of the network switch so that electronic components connected to these ports can exchange low-level protocol frames T.

According to one embodiment, the low-level protocol is of the CAN XL type in accordance with the CiA 610-1 and CiA 610-3 specifications and the packet-switching protocol is of the Ethernet type (standard 802), that is a protocol operating with 100Base-T1 Ethernet transceivers.

The frame T of a CAN XL network protocol comprises seven fields as shown in FIG. 2:
the Start of Frame (SOF) signaled by 1 dominant bit;
the arbitration field (identifier) composed of 12 or 32 bits;
the control field composed of 6 bits and comprising a DLC, Data Length Code, indicating the length of the data (payload);
the data field composed of 0 to 64 bits (from 0 to 8 bytes);
the CRC field composed of 16 bits;
the acknowledgment (ACK) field composed of 2 bits;
the End of Frame (EOF) signaled by 7 recessive bits.

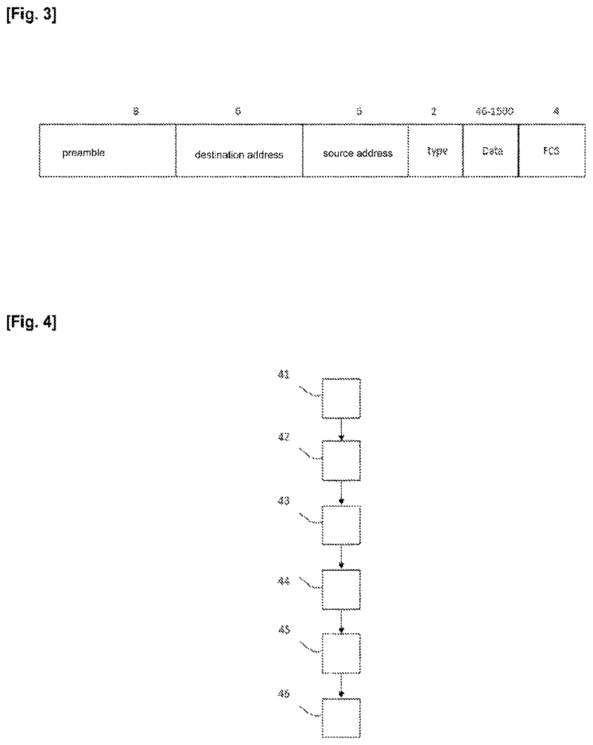

FIG. 3 shows the main fields of an Ethernet frame.

Among these fields, the source and destination addresses are expressed in 6 bytes.

According to this embodiment, the MAC addresses of the Ethernet type are expressed in 6 bytes and the source or destination addresses of the frame T of the CAN XL protocol are expressed in 2 bytes.

In the case where the addressing table 122 stores MAC addresses, each stored MAC address is then entered from the 2 bytes of an address extracted from the frame T which are completed by 2 padding bytes.

The network switch 12 can then operate as an Ethernet network switch implementing the mechanism for redirecting the frames T of the low-level protocol on the basis of an Ethernet type MAC address.

The network switch 12, operating on the basis of the MAC address or low-level protocol addresses, can also implement other features conventionally used on incoming Ethernet frames. For example, one of these features is the management of the VLANs (Virtual Local Area Network) based on a VID field of the Ethernet protocol expressed in 12 bits.

In a fifth operation (optional), for the network switch 12 to be able to implement this management of the VLANs, the first eight bits of the VID field are populated by a VCID field extracted from the frame T of the low-level protocol and completed by four padding bits.

In a sixth operation (optional), certain frames or VLANs may be blocked by implementing a firewall feature.

According to one variant, the frame T being a frame of the low-level protocol or a frame of the packet-switching protocol, information INF is stored to identify whether an input port 121ₙ or output port 123ₘ of the network switch accepts frames of the low-level protocol or frames of the packet-switching protocol.

The choice of using addressing tables storing either low-level protocol addresses or MAC addresses can depend on the type of frames received on the input and/or output ports.

The elements of the network switch 12, individually or in combination, can be integrated into a single integrated circuit, in several integrated circuits, and/or in discrete components.

The network switch 12 can be made in the form of electronic circuits or software (or computer) modules or a combination of electronic circuits and software modules.

The controllers 122ₙ (n=1 to N) and/or the processor(s) 125 is (are) configured to execute instructions for performing the operations of FIG. 1 and/or the steps of the method of FIG. 4. The controllers 122n and/or the processor 125 may include integrated memory, an input/output interface, and different circuits known to the person skilled in the art. The memory 126 corresponds, for example, to a volatile and/or non-volatile memory and/or comprises a memory storage device which may comprise volatile and/or non-volatile memory, such as EEPROM, ROM, PROM, RAM, DRAM, SRAM, flash, magnetic or optical drive.

The computer code comprising the instructions of the method of FIG. 4 to be loaded and executed by the controllers 122ₙ and/or the processor 122 is for example stored on the memory 126.

FIG. 4 shows a flowchart of the various steps of a method for transmitting a signal from a first electronic component of a vehicle to at least one second electronic component of the vehicle according to a particular exemplary embodiment.

In a first step 41, a signal is generated from a low-level protocol frame T and received on a physical input port of the network switch 12.

In a second step 42, the frame T, extracted from the received signal, is redirected to an output port of the network switch 12 on the basis of at least one destination address extracted from this frame T.

In a third step 43, a signal is generated from the frame T and transmitted to the electronic component identified by the destination address extracted via said output port of the network switch 12 to which this electronic component is connected.

In a fourth step 44 (optional), a source address is extracted from the frame T and stored in the addressing table 122 in association with the number of the input port of the network switch on which the frame T is received, if this association is not already stored in the addressing table 122.

In a fifth step 45 (optional), the frame T is adapted to populate the VID field of the Ethernet protocol with the 8 bits of the VCID field of the frame of the CAN XL protocol completed by 4 padding bits.

In a sixth operation 46 (optional), certain frames or VLANs may be blocked by implementing a firewall feature.

According to a variant embodiment, the variants and examples of the operations described in relation to FIG. 1 apply to the steps of the method of FIG. 4.

Of course, the devices and methods described are not limited to the embodiments described above but extends to a method for transmission of a signal from a first electronic component of a vehicle to at least one second electronic component of the vehicle that includes secondary steps without departing from the scope of the description. The same applies to a device configured to implement such a method.

The described methods and devices also relate to a vehicle, for example a motor vehicle, comprising a system according to FIG. 1.

1. A method for transmitting a signal from a first electronic component of a vehicle to at least one second electronic component of the vehicle, said signal being formed from a frame of a low-level network protocol and being transmitted via transceivers of a packet-switching protocol, the method comprising the following steps:
receiving the signal on a physical input port of a network switch;
redirecting the frame of the low-level network protocol extracted from the received signal to an output port of the network switch based on a destination address extracted from said low-level network protocol frame;
transmitting a signal, generated from the frame of the low-level network protocol, to the electronic component identified by the extracted destination address via said output port of the network switch to which said electronic component is connected.

2. The method according to claim 1, wherein the frame of the low-level network protocol is redirected to an output port whose number is stored in an addressing table in association with a destination address identical to the destination address extracted from the frame of the low-level network protocol.

3. The method according to claim 2, wherein the destination address extracted from the frame of the low-level network protocol is stored in the addressing table in association with the number of the input port if this association is not already stored in the addressing table.

4. The method according to claim 1, wherein the frame of the low-level network protocol is redirected to an output port whose number is stored in the addressing table in association with a destination address of the packet-switching protocol obtained from a destination address identical to the destination address extracted from the frame of the low-level network protocol.

5. The method according to claim 4, wherein the destination address of the packet-switching protocol is stored in the addressing table in association with the number of the input port if this association is not already stored in the addressing table.

6. The method according to claim 1, which further comprises a step of extracting a source address of the frame of the low-level network protocol and of storing said source address in an addressing table in association with the number of the input port of the network switch on which the frame of the low-level network protocol is received.

7. The method according to claim 1, which further comprises a step of extracting a source address of the frame of the low-level network protocol and of storing said source address of the packet-switching protocol obtained from said extracted source address, in an addressing table in association with the number of the input port of the network switch on which the frame of the low-level network protocol is received.

8. The method according to claim 1, wherein information is stored to identify whether an input port of the network switch accepts low-level protocol frames or packets of the packet-switching protocol.

9. A network switch comprising a memory associated with at least one processor configured to implement the steps of the method according to claim 1.

10. A vehicle comprising the device according to claim 9.
